(19) United States
(12) Patent Application Publication
(10) Pub. No.: US 2013/0312049 A1
(43) Pub. Date: Nov. 21, 2013

(54) AUTHORING, ARCHIVING, AND DELIVERING TIME-BASED INTERACTIVE TV CONTENT

(71) Applicants: Somrat NIYOGI, Burlingame, CA (US); Timothy Lee, San Francisco, CA (US)

(72) Inventors: Somrat NIYOGI, Burlingame, CA (US); Timothy Lee, San Francisco, CA (US)

(73) Assignee: GoMiso, Inc., San Francisco, CA (US)

(21) Appl. No.: 13/476,992

(22) Filed: May 21, 2012

(51) Int. Cl. H04N 21/60

(52) U.S. Cl. 725/110

(57) ABSTRACT

A social television system provides for the authoring, archiving, and delivering of interactive social television content. A social television service provider receives the identity of a television show that is being watched on a first display screen. The social television service provider delivers corresponding social television content to a second display screen. The social television content is to be displayed on the second display screen at certain timeframes during the playback of the television show on the first display screen. Various entities may author social television content. The authoring process may be facilitated by obtaining data from web-based data sources. The authoring process may take place via a website hosted by the social television service provider. The authoring process may also take place via a third-party website that is connected to the social television service provider via a software development kit.

### BACKGROUND

1. Field

The present disclosure relates generally to social television and, more specifically, to authoring, archiving, and/or delivering social television content.

2. Description of Related Art

Conventional television technologies allow for the delivery of video and audio content to consumers for consumption. Typically, a television show is recorded by a content producer, such as a television studio, and is distributed for mass consumption in its as-recorded form, save for minor programming edits and the addition of advertisements. Consistent with its plain and ordinary meanings, the term “television show” may refer to one part of a recurring series, such as an episode in a drama series. Further, the term may refer to a one-time production, such as a broadcast of a sports event. Further still, the term may refer to television content found on pay-per-view, video-on-demand, Internet-streaming, and/or shopping channels.

Television shows are typically adapted for viewing via a single television screen, meaning that the visual content of a television show can be fully displayed on a single television screen (though multiple televisions may display the same television show, for example, in different households). Further, television shows generally allow little, if any, interaction with the viewer. That is to say, beyond the functionalities typically provided by television set top boxes (e.g., DVR functions, click-to-shop, and so forth), a television viewer generally cannot interact with the television show that is being presented on-screen. For at least these reasons, a television viewer's attention to a television show often fades.

### BRIEF SUMMARY

In one exemplary embodiment, an internet-based social television services provider receives the identity of a television show that is being displayed on a first display screen. The social television services provider also receives, from a user, a first social television content object. The first social television content objects corresponds to a portion of the television show that is being displayed on the first display screen, and the first social television content object includes visual data. The social television services provider also receives, from another user, a second social television content object. The second social television content object corresponds to a portion of a television show that is not being displayed on the first display screen. The second social television content object includes visual data, and the second user and the first user are different users. The social television services provider transmits, for display on a second display screen, one of the first social television content object and the second social television content object, based on the received identity of the currently displayed television show. The social television content object that is transmitted corresponds to a portion of the currently displayed television show (on the first display screen). The transmitted social television content object is to be displayed on the second display screen when the corresponding portion of the currently displayed television show is displayed on the first display screen.

In one exemplary embodiment, an internet-based web page allows a user to author social television content that is to be displayed contemporaneously with the display of a television show on a first screen. The web page for authoring is produced by a (authoring) website and received by a web browser. The (authoring) website retrieves from a social media website, using a uniform resource locator, a plurality of user-generated content objects. The objects may be images, videos, music clips, or the like. The web page includes a region for authoring a social television content object, the web page references at least one of the plurality of retrieved user-generated content objects. The web page allows the social television content author to select at least one of the plurality of retrieved user-generated content contents for use in the social television content object that is being authored. The (authoring) website receives, by way of the web page, the authored social television content object. The social television content object is to be displayed on a second display screen when the corresponding portion of the television show is displayed on the first display screen.

In one exemplary embodiment, an internet-based web page allows a user to author social television content that is to be displayed contemporaneously with a display of a television show on a first screen. The web page is hosted by a social media website. The web page includes a region for authoring a social television content object that is produced by a social television services provider via SDK (software development toolkit) functions. The authoring region of the web page references at least one of a plurality of retrieved user-generated content objects from a social media website accessed via a uniform resource locator. The objects may be images, videos, music clips, or the like. The authoring region of the web page allows the television content author to select at least one of the plurality of retrieved user-generated content contents for use in the social television content object that is being authored. The social television services provider, by way of the web page and the SDK, the authored social television content object. The social television content object is to be displayed on a second display screen when the corresponding portion of the television show is displayed on the first display screen. The SDK functionalities may be provided using HTML, JavaScript, and CSS.

### DESCRIPTION OF THE FIGURES

FIG. 1 is a diagram depicting an exemplary use of Social Television (“TV”) technologies.

FIG. 2 is a block diagram depicting components in an exemplary Social TV system.

FIG. 3 depicts exemplary Social TV content.

FIG. 4 depicts an exemplary Social TV content authoring tool.

FIG. 5 depicts an exemplary Social TV content authoring tool.

FIGS. 6A-C depict an exemplary Social TV content authoring tool.

FIG. 7 depicts an exemplary Social TV content authoring tool.

FIG. 8 depicts an exemplary Social TV content authoring tool.

FIGS. 9A-B depict an exemplary Social TV content authoring tool.

FIG. 10 depicts exemplary authoring, archiving, and delivering of Social TV content using a Social TV platform.

FIG. 11 depicts an exemplary grouping of Social TV content.

FIG. 12 depicts exemplary displays of Social TV content.

FIG. 13 depicts additional exemplary displays of Social TV content.

FIG. 14 depicts exemplary time-shifted displays of Social TV content.

FIG. 15 is a block diagram depicting an exemplary process of a Social TV content system.

FIG. 16 is a block diagram depicting an exemplary process of a Social TV content system.

FIG. 17 is a block diagram depicting an exemplary process of a Social TV content system.

FIG. 18 is a block diagram depicting an exemplary system for implementing portions of a Social TV platform.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

The embodiments described herein include Social television (“Social TV”) technologies for incorporating social interaction and interactive content (“Social TV content”) into the context of television technologies. While a television viewer views a television show on a television, Social TV technologies can provide additional, Social TV content to the viewer via a second display screen. The additional Social TV content may: (i) allow a television viewer to interact with the Social TV content, (ii) originate from a number of content sources other than (but not excluding) a television producer, and (iii) allow a television viewer to interact with another television viewer.

As used herein, the term “first display screen” refers to a device that is capable of displaying a television show. Non-limiting examples of a “first display screen” include a household LCD television, LED computer display, and the like, that is displaying a television show. The term “second display screen” refers to an electronic device that is capable of displaying visual and/or aural content complementary to the television show (e.g., Social TV content) that is being displayed on the first display screen. Non-limiting examples of a “second display screen” include a smart phone, tablet computer, and the like, that is producing Social TV content. It should be noted that the distinction between a “first display screen” and a “second display screen” is not solely based on the size of a device. For example, a smart phone that is streaming a television show can act as a “first display screen” while a larger tablet computer can act as a “second display screen.”

In one embodiment, the first display screen and the second display screen are physically separate devices, such as an LCD television and a smart phone, respectively. In one embodiment, the first display screen and the second display screen share the same physical display device. For example, a “smart” television may display a television show as well as Social TV content on the same physical display screen and, thus, the smart television acts as both the first display screen and the second display screen.

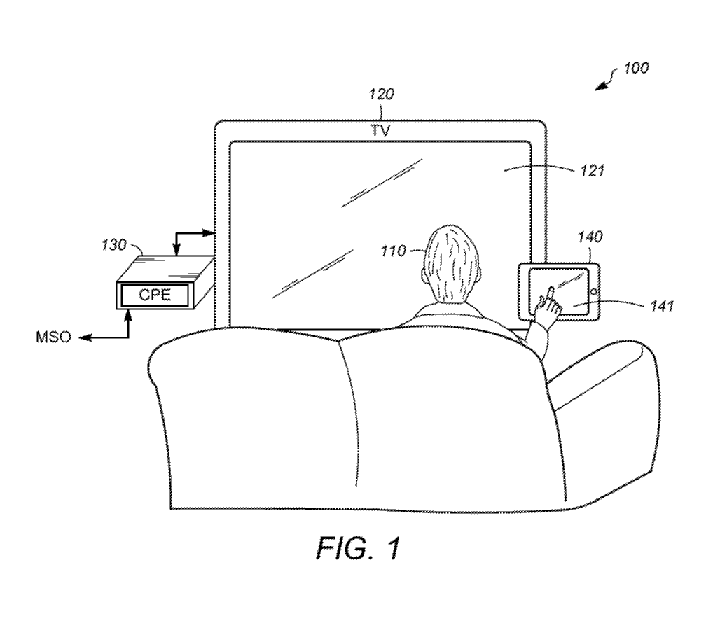

FIG. 1 illustrates an exemplary embodiment of Social TV technologies in the context of a household. As shown, household 100 includes television viewer 110 and first display screen 120 on which a television show 121 is displayed. First display screen 120 may include an LCD television and may be showing an episode of the Jeopardy™ game show. First display screen 120 may receive television programming from a Multiple System Operator (“MSO”) via Consumer Premises/Provided Equipment (“CPE”) 130. Further, household 100 includes second display screen 140 on which Social TV content 141 is displayed. Second display screen 140 may include a tablet computer on which Social TV content 141 in the form of an interactive companion Jeopardy™ game (which corresponds to the Jeopardy episode being displayed on first display screen 120) is displayed. Social TV content 141 may be interactive in that its contents respond to inputs from television viewer 110.

Consistent with the accepted meaning of the term in the art, MSOs may also be referred to as cable companies, one non-limiting example of which is Comcast Corporation. Also, consistent with the generally accepted meaning of the term in the art, non-limiting examples of CPEs include television set-top boxes, multimedia players, or the like.

### 1. Social TV System Architecture

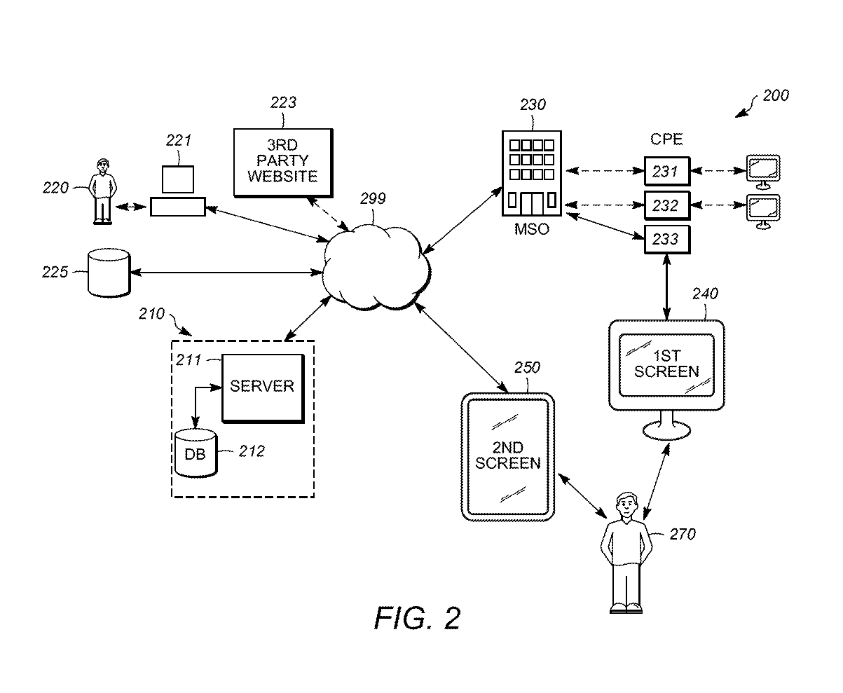

FIG. 2 illustrates an exemplary Social TV system 200 that supports authoring, archiving, and/or delivering of Social TV content. Exemplary Social TV system 200 includes Social TV services provider 210, which may include Server 211 and database 212. Server 211 may include computer instructions for hosting web pages for the creation, read, update, and/or deletion (“CRUD”) of Social TV content in Social TV system 200. Server 211 may also include computer instructions for providing web services that allow for the CRUD of Social TV content via third-party websites that are in communication with Social TV system 200.

Social TV system 200 places no particular restrictions on the entities that may act as Social TV content providers. Social TV services provider 210 may receive Social TV content from a human author 220. Non-limiting examples of human authors include a user of a social network website, a member of a network studio, a television enthusiast, a blogger, or the like. Human author 220 may provide Social TV content using computer 221 that is in communication with Social TV services provider 210 via network 299. Computer 221 may present a web page to human content source 220 for creating Social TV content. The web page may be provided by server 211 or may be provided by a third-party website (e.g., a social networking website) that is in communication with server 211.

Social TV services provider 210 may also receive Social TV content from a nonhuman data provider, such as content source 225, that is connected to Social TV services provider 210 via network 299. Non-limiting examples of a nonhuman data provider include third-party data repositories of social media, e-commerce, news, web-based user-generated content, or the like. One skilled in the art will appreciate that data feed mechanisms, such as RSS, RDF, XML, or the like, may be used to provide Social TV content from nonhuman data provider 225 to Social TV services provider 210. Network 299 may include the Internet, an intranet, or a network that has both public and private networked portions. Network 299 may have wired and/or wireless portions. Social TV server 211 stores Social TV content created by content sources into database 212.

Exemplary Social TV system 200 communicates with MSO 230, which provides television programming to television viewers via CPEs 231-233. CPE 233 receives a television show from MSO 230 and in turn provides the received television show to first display screen 240 for display. MSO 230 and/or CPE 233 may provide information regarding the television show that is being displayed on first display screen 240 to Social TV services provider 210 via network 299. The provided information may include the identity and the specific portion of the television show that is being displayed. The provided information may also include the billing entity that is associated with CPE 233.

Exemplary Social TV system 200 also communicates with second display screen 250. Second display screen 250 communicates with Social TV services provider 210 via network 299. Second display screen 250 may obtain information regarding the television show that is being displayed on first display screen 240 using aural and/or visual recognition technologies. Second display screen 250 may additionally or alternatively obtain information regarding the television show that is being displayed on first display screen 240 via a direct connection to CPE 233. In either case, once the television show information is obtained by second display screen 240, second display screen 240 may provide the obtained information to Social TV services provider 210. Second display screen 250 may also provide information about its viewer (e.g., information from a stored profile) to Social TV services provider 210. Based on information transmitted from MSO 230, CPE 233, and/or second display screen 250, Social TV services provider 210 transmits Social TV content that corresponds to television show that is being shown on first display screen 240 to second display screen 250 for display on second display screen 250.

As is apparent from the foregoing descriptions, portions of exemplary Social TV system 200 are adapted to support the authoring, archiving, and/or displaying of Social TV content. These aspects of Social TV system 200 are discussed below.

### 2. Displaying Social TV Content

While a television show is being displayed on a first display screen, a Social TV system may provide, for display on a second display screen, Social TV content corresponding to the television show that is being displayed on the first display screen. Social TV content that is displayed on the second display screen may be referred to as a companion show or, for brevity, a sideshow.

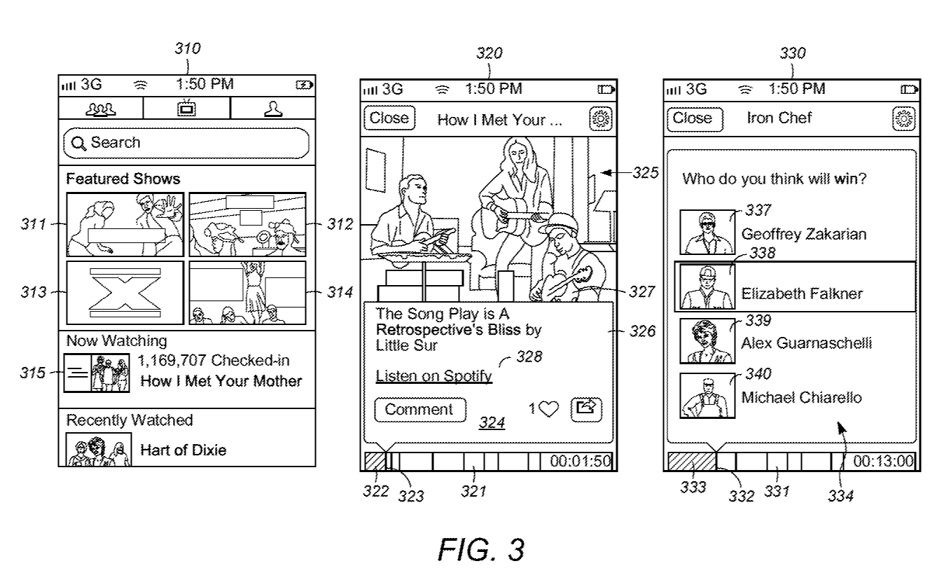

FIG. 3 illustrates an exemplary selection and display, on a second display screen, of a sideshow corresponding to a television show that is being displayed on a first display screen. In view 310, images 311-314 represent television shows for which one or more sideshows may be available for display on a second display screen. Optionally, the second display screen may recognize, via a CPE, the television show that is currently being displayed on the first display screen and display image 315, which represents the displayed television show (and for which one or more sideshows may be available). When a viewer selects one of images 311-315, a sideshow corresponding to the represented television show becomes displayed on the second display screen. Note, multiple sideshows may be available via the Social TV system for a particular television show. If an image that has been selected by the viewer represents a television show for which multiple sideshows are available, an intermediate view (not shown) may allow the viewer to further select one of the available sideshows for viewing on the second display screen.

View 320 illustrates an exemplary display of a sideshow 325 on a second display screen. Sideshow 325 includes timeline 321, which contains progress indicator 322 and various markers. Progress indicator 322 indicates the portion of the sideshow that is currently being displayed on the second display screen. The left and right boundaries of timeline 321 correspond to the start and end of the sideshow. The left and right boundaries of timeline 321 also correspond to the start and end of the television show that is being displayed on the first display screen. Typically, the progress of a sideshow coincides with the progress of the corresponding television show. Markers on timeline 321 indicate the availability of Social TV content that may be displayed in view 320 from time to time. For instance, marker 323 indicates that sideshow object 324 relevant to the 1 minute 50 seconds mark of the corresponding television show is available for display. Other markers displayed along timeline 321 indicate the availability of additional sideshow objects that are relevant to various portions of the corresponding television show.

As used herein, a sideshow object is a component of a sideshow that acts as a container of computer data and/or metadata. A non-limiting example of data is text 326. A non-limiting example of metadata is a resource locator, such as a uniform resource locator (“URL”), to a JPEG file containing image 327. Computer data and metadata may be static and/or dynamic. Static computer data and metadata can be presented visually or aurally to a viewer but do not otherwise allow for interaction between the displayed information and the viewer. A non-limiting example of static computer data is text 326. In contrast, dynamic computer data and metadata allow for interaction. A non-limiting example of dynamic data is computer instructions that are invoked in response to a viewer input, such as computer instructions that cause the display of voting results when a viewer selects one of buttons 337-340. Since a sideshow is a type of Social TV content, it follows that a sideshow object is an exemplary Social TV content object.

Typically, the display of a sideshow on a second display screen is synchronized with the playback progress of a corresponding television show on a first display screen. That is, based on information transmitted to the second display device from a MSO, CPE, and/or Social TV services provider (such as 230, 233, and/or 210 in FIG. 2), the second display screen may display a portion of a sideshow while relevant to a portion of a television show is being displayed on the first display screen. However, progress indicator 322 may be affected by viewer input. For example, a viewer may drag progress indicator 322 to override the timing and speed at which sideshow objects are displayed. A viewer may also manually synchronize the position of progress indicator 322 to match the display of the sideshow on the second display screen with the playback progress of the corresponding television show on the first display screen.

Exemplary view 320 of FIG. 3 includes sideshow object 324 having image 327, which may represent a scene in the corresponding television show (displayed on the first display screen) in which a song is being played. As discussed above, the display of sideshow object 324 on the second display screen may be configured to coincide with the particular scene in the corresponding television show. Text 326 may indicate the name of the song that is audible in the particular scene. Link 328 may include computer instructions for redirecting the viewer of the second display screen to an application for obtaining the same song.

Entities in a Social TV system may benefit financially in the viewing of sideshow objects. The financial benefits may be structured in the form of an “affiliate program” between, for example, an entity in a Social TV system and an e-commerce merchant. As is well understood, e-commerce merchants often provide, under an “affiliate program,” commissions to entities (i.e., affiliates) that direct web traffic to their e-commerce store front. Sometimes, a commission is given to an affiliate when the directed web traffic results in a purchase from the e-commerce. In the context of a Social TV system, an “affiliate program” may be structured such that, for example, when a sideshow object author provides a link in a sideshow object to a music merchant, the music merchant provides a commission to the sideshow object author when a viewer of the sideshow object clicks-through the provided link to download a sound track from the music merchant. For its part in providing a Social TV system that enabled the purchase, a Social TV services provider may also receive a commission based on the same purchase.

In some embodiments, the above-described techniques for causing the display of a sideshow on a second display screen are provided by computer instructions packaged in a mobile device program, such as an iOS application or an Android widget. In some embodiments, the above-described techniques are provided by computer instructions embedded into a web page that may be downloaded onto a computing device. For example, the embedded computer instructions may cause a computing device to contact a Social TV services provider (e.g., 210 in FIG. 2) for a web application that is able to cause the display of a sideshow on the computing device. In some embodiments, the above-described techniques are provided by portions of a multimedia device, such as a “smart TV,” a media player, or some other CPE.

### 3. Authoring Social TV Content

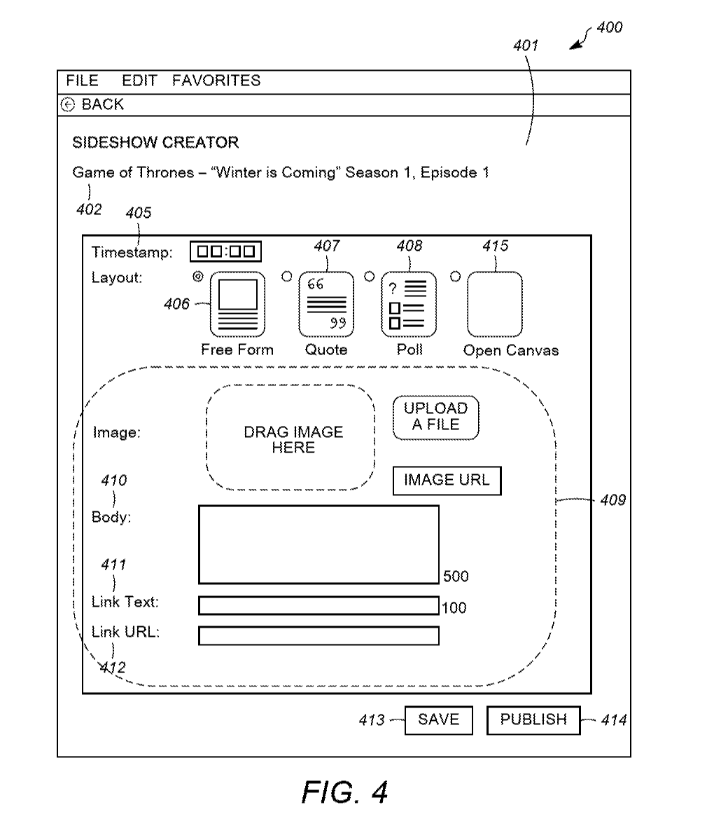

As discussed above with respect to FIG. 2, a Social TV services provider may receive Social TV content from a human author 220. In one embodiment, a Social TV services provider may provide a web page for the CRUD of Social TV content. FIG. 4 illustrates exemplary web page 400 that may be used by a human to author Social TV content in the form of a Social TV sideshow object. Sideshow object 401 is a part of a sideshow that corresponds to the television show 402. Timestamp 405 indicates the relevance of sideshow object 401 to a particular portion of television show 402, meaning that the author of sideshow object 401 intends for the content of region 409 to be displayed to a television viewer contemporaneously at the amount of time indicated by timestamp 405 into television show 402. Note, the contemporaneous display of sideshow object 401 with television 402 at timestamp 405 may last for a default duration, or may be configured by the Social TV content author.

Web page 400 provides exemplary What-You-See-Is-What-You-Get (“WYSIWYG”) layouts 406-408 that control the look and feel of sideshow object 401, which is to be displayed on a second display screen. That is, layout 406 may control, for example, the look and feel of sideshow object 324 (FIG. 3). Exemplary layouts 406-408 allow for the inclusion of data and/or metadata, each of which may be static and/or dynamic, into sideshow object 401. The contents of region 409 update based on the selection of a layout among layouts 406-408. As shown, the contents of region 409 correspond to layout 406 and allows for the inclusion of text 410, which is static data, into sideshow object 401. Region 409 also allows for the inclusion of an URL to image 411, which is static metadata, into sideshow object 401. Still, region 409 also allows for the inclusion of additional link 411 to URL 412 into sideshow object 401.

A sideshow object author may click button 413 to save the authored portions of sideshow object 401. A sideshow object author may also complete the authoring of sideshow object 401 by clicking button 414, which causes the authored content to be transmitted to a Social TV services provider. Once a sideshow author completes the sideshow authoring progress via button 414, a Social TV services provider may make the authored sideshow object available for delivery to second display screens for display.

In one embodiment, a Social TV services provider may provide computer instructions, for example, in the form of a software development kit (“SDK”) that allow for the CRUD of Social TV content via third-party websites that are in communication with the Social TV services provider. That is, portions of exemplary web page 400 may be provided via a SDK for display as part of web page that is served by a third-party website. Such a SDK may utilize JavaScript, HTML, CSS, and the like for transferring exemplary web page 400, in whole or in part, to the third-party website. The third-party website may combine the transferred portions of web page 400 into a larger web page using technologies such as an “iframe.” One of ordinary skill in the art would appreciate an “iframe” is an HTML element that is documented by applicable HTML standards. The third-party website may be a social media website.

3a. Layouts

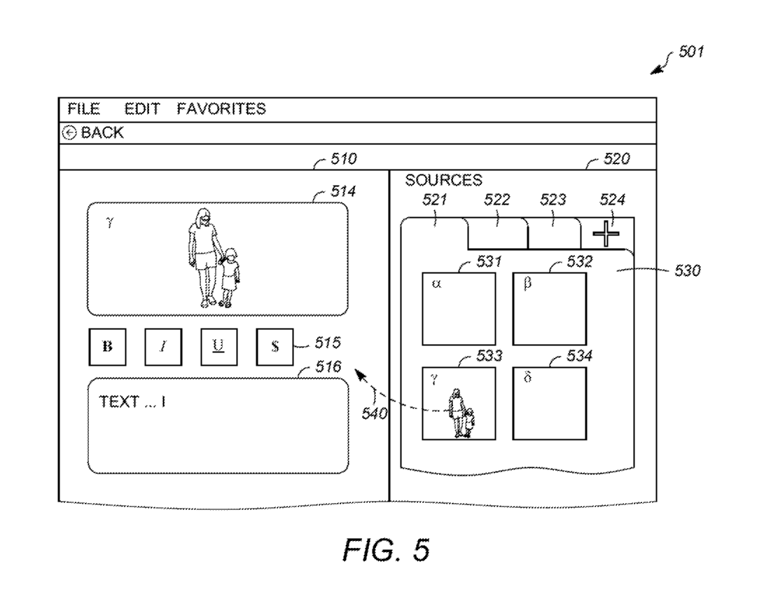

Although FIG. 4 illustrates exemplary layouts 406-408 for controlling the look and feel of sideshow objects, other layouts are possible. Notably, more advanced layouts may allow a sideshow object author to reference content from nonhuman content sources into a sideshow object that is being authored. FIG. 5 illustrates exemplary layout 501 that may be displayed in region 409 of sideshow object 401 (FIG. 4). As shown, layout 501 includes region 520 which allows a sideshow author to reference content from exemplary nonhuman content sources represented by tabs 521-523. The nonhuman content sources may be data repositories of social media, e-commerce, news, web-based user-generated, or the like. For example, tab 521 may represent an image repository, such as Flikr™, tab 522 may represent Twitter™, and tab 523 may represent eBay™. When a sideshow object author selects one of tabs 521-523, information related to the represented nonhuman content source is displayed in region 530. When tab 521 (i.e., Flikr™) is selected, images 531-534 may be displayed in region 530. When tab 522 (i.e., Twitter™) is selected, short text messages may be displayed in region 530. When tab 523 (i.e., eBay™) is selected, auction listings may be displayed in region 530. A sideshow object author may populate region 510 with one or more of the objects displayed in region 530. For example, arrow 540 represents the dragging and dropping of image 533 from region 530 into region 510. In this way, image 533 becomes connected to the sideshow object that is being authored, meaning that image 533 may be displayed during playback of sideshow object. In addition, image 533 may be associated with a URL so that a viewer of the sideshow object may select image 533 and be directed to the associated URL. Region 510 also includes text box 516 and text tools 511-513 for the entry of text along image 514.

As discussed above, content sources may provide affiliate programs. Thus, the viewing of and/or interaction with a sideshow object may result in a commission being given to the author of the sideshow object. A Social TV system may maintain the amount of commission generated by a sideshow object. For example, revenue meter 515 may be displayed in a sideshow layout to indicate the amount of commission that has been derived from the sideshow object.

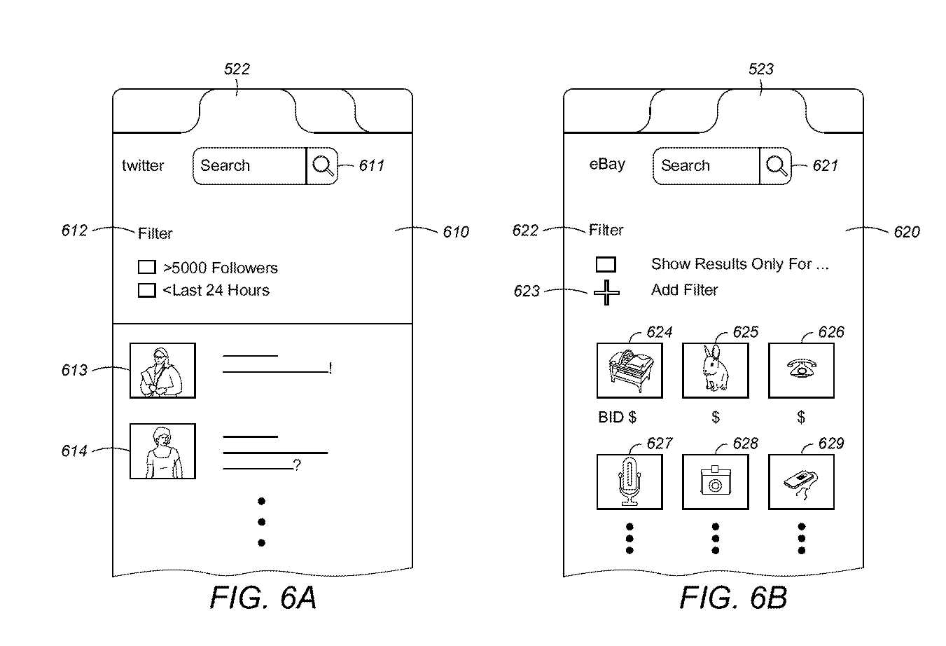

FIG. 6A illustrates region 610 associated with exemplary tab 522 representing Twitter™. When tab 522 (FIG. 5) is selected, region 610 may be displayed in region 520 (FIG. 5). Region 610 includes search field 611 for searching text messages associated with Twitter™ accounts and/or metadata (e.g., hashtags) of the microblog represented by tab 522. Region 610 also includes filters 612 for filtering the results of a search based on search field 611. As shown, the displayed search results include text messages 613 and 614. A sideshow object author may reference, in region 510 (FIG. 5), one or more of the text messages displayed in the search results by, for example, dragging and dropping text messages 613 into region 510 (FIG. 5).

FIG. 6B illustrates region 620 associated with exemplary tab 523 representing eBay™. When tab 523 (FIG. 5) is selected, region 620 may be displayed in region 520 (FIG. 5). Region 620 includes search field 621 for searching items that are for sale at the e-Commerce web represented by tab 523. Region 620 also includes filters 622 for filtering the results of a search based on search field 621. Additional filters may be added via widget 623. Additional filters may be based on metadata maintained by nonhuman content source 523, such as seller name, item price, item category, and so forth. As shown, the displayed search results include images related to auctions 624-629. A sideshow object author may reference, in region 510 (FIG. 5), one or more of the auctions displayed in the search results by, for example, dragging and dropping auction 624 into region 510 (FIG. 5).

Turning back to FIG. 5, region 520 also includes tab 524 for adding a nonhuman content source that is not currently represented by a tab in region 520. With reference to FIG. 6C, when a sideshow object author selects tab 524, region 630 may be displayed in region 520 (FIG. 5). Region 630 includes text box 631 in which the sideshow object author can enter the URL for accessing a nonhuman content source. As one of ordinary skill the art would appreciate, the URL refers to a resource that provides the JavaScript, CSS, and/or HTML that are necessary for the Social TV system to communicate with the nonhuman content source. Region 630 may also include links 632-634 to other nonhuman content sources that may have been configured by system administrators or other sideshow object authors of the Social TV system, but have not been made available by way of tabs on region 520 (FIG. 5) that are visible to the sideshow object author. When a sideshow object author populates a valid URL into text box 631 or selects one of pre-configured links 632-634, a new tab 635 is created for the newly available nonhuman content source.

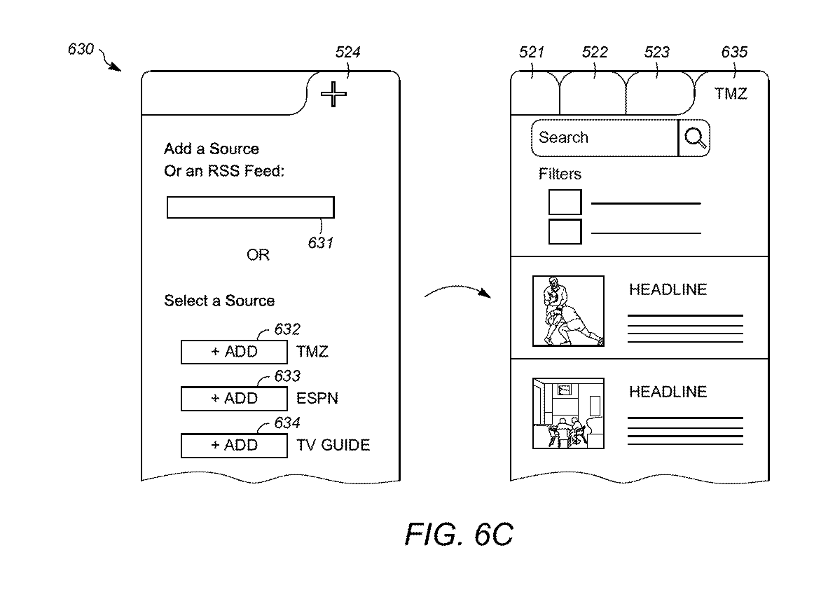

In addition to the exemplary layouts 406-408 shown in FIG. 4, and the additional exemplary layouts discussed with respect to FIGS. 5-6, a sideshow object author may create new layouts. FIG. 7 illustrates exemplary layouts 710, 720, and 730 that may be created by a sideshow object author. For example, layout 710 is a layout having text regions that are stylized as dialogues, layout 720 is a layout having short text, or “tweet,” regions, and layout 730 is an image collage that is stylized with the theme of the Brady Bunch television series. Layout 730 includes checkbox 731 for indicating that layout 730, created by one sideshow author, can be shared with other sideshow object authors of the Social TV system. A shared layout may appear in a web page, referred to as a layout showcase, where sideshow objects are displayed to sideshow object authors for selection. One of ordinary skill in the art would appreciate that other layouts are possible. For example, a circle layout where there is a face, a guest star layout, a music layout, a video layout, a map layout, a Twitter™ “follow” layout, a Facebook™ “like” layout, and so forth.

3b. Open Canvas

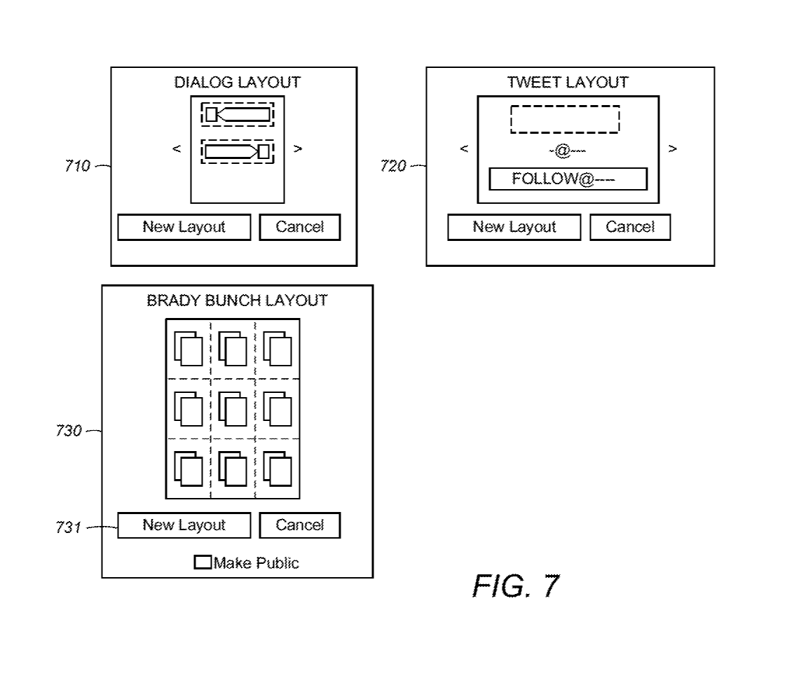

Turning back to FIG. 4, web page 400 may also provide an open canvas 415 for controlling the look and feel of sideshow object 401, which is to be displayed on a second display screen. That is, open canvas 415 may be populated with computer source code (e.g., HTML, Flash, or the like) that are transmitted to and executed on a second display screen. The contents of region 409 update based on the selection of open canvas 415. FIG. 8 illustrates exemplary open canvas 801 that may be displayed in region 409 of sideshow object 401 (FIG. 4). Open canvas 801 includes computer source code region 802 and displays the computer source code in text form. A sideshow object author may enter computer source code into computer source code region 802.

For example, the computer source code may present an interactive “Happy or Not Happy Meter” application on a second display screen. The Happy or Not Happy Meter application may be displayed on a second display screen as a sideshow object contemporaneous with the display of a television show on a first display screen. A viewer may interact with the Happy or Not Happy Meter to indicate the viewer's satisfaction with the storyline of the television show. The viewer's selection of “Happy” or “Not Happy” may be communicated to other entities in a Social TV system, such as a Social TV services provider. In this way, the satisfaction of multiple viewers (as represented by each viewer's interaction with the “Happy or Not Happy Meter” application) may be collected and shared with other viewers in the Social TV system.

As another example, the computer source code may present a “text-to-vote” function on a second display screen. Various television shows now allow viewers to vote for a participant of the television show via Short Message Service (SMS), which is generally a service that is provided by a cellular telephone service provider. The “text-to-vote” function may be displayed on a second display screen as a sideshow object contemporaneous with the display of a reality television competition on a first display screen. The “text-to-vote” function may include a number of buttons that correspond to the participants of the competition. When a viewer selects one of the buttons displayed on the second display screen, the computer source code may initiate a SMS text message to a collector of votes for the competition. Note, the computer source code may initiate another cellular telephone service. For example, the computer source code may initiate a phone call (e.g., “call-to-vote”).

As another example, the computer source code may invoke a notification message on a second display screen. For instance, the computer source code may include a push notification, which can be used to invoke a notification message on an Apple™ device. The computer source code may also include a C2DM instruction, which can be used to invoke a notification message on a device running the Google Android™ platform. Note, these notification mechanisms are generally considered to be data services that are distinguished from cellular telephone service.

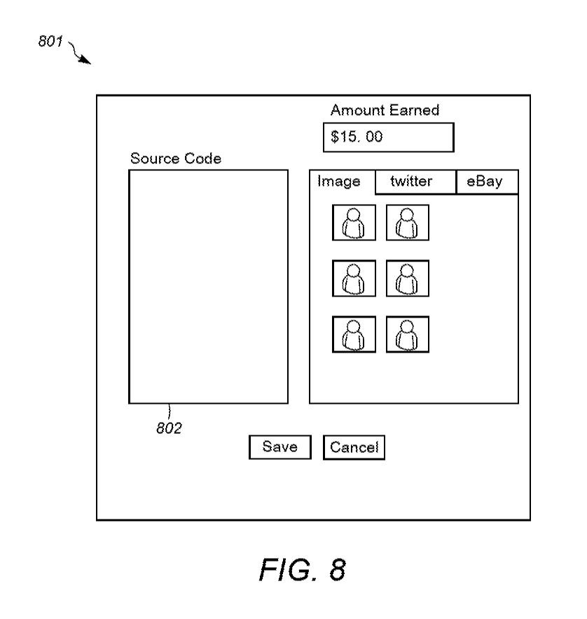

FIGS. 9A and 9B illustrate an exemplary open canvas 900 that may be displayed in region 409 of web page 400 (FIG. 4). Open canvas 900 includes WYSIWYG computer source code region 901. In contrast to computer source region 802 (FIG. 8), WYSIWYG computer source code region 901 does not display computer source code. Rather, WYSIWYG computer source code region 901 renders web elements that are associated with computer source code. The associated computer source code is entered through region 906. In this way, a sideshow object author may review a sideshow object as it would appear when it is displayed on a second display screen, and access the computer source code that support the web elements in the sideshow object via a separate region 906. Open canvas 900 includes tool box 902. Tool box 902 includes tools for creating web elements (e.g., buttons, images, so forth) and their accompanying computer source code. For example, tool box 902 may include button tool 903 for creating a button in a sideshow object. A sideshow object author may drag and drop button tool 903 into WYSIWYG computer source code region 901 to create a button 904. Button 904 may include computer source code for initiating server-side action by a server that is accessible via the Social TV system. Button 904 may also include computer source code for receiving information from a server that is accessible via the Social TV system, such as from the server that is executing the server-side action invoked by button 904.

One of ordinary skill in the art would appreciate that the computer source code entered into WYSIWYG computer source code region 901 (and/or computer source code region 802 as shown in FIG. 8) is not particularly limited by the Social TV system. Rather, the syntax and features of the entered computer source code is controlled by the particular programming language that is being used. Thus, current and future technologies such as HTML, Flash, and Java may allow new web functionalities to be implemented into a sideshow object via an open canvas. For instance, using HTML5, it is possible to include, into WYSIWYG computer source code region 901 (and/or computer source code region 802 as shown in FIG. 8), branching logic that responds to input from a viewer. That is, when the sideshow object corresponding to open canvas 901 is displayed on a second display screen, the sideshow object may present different information to the viewer based on whether the viewer selects button 904 or button 905.

3c. Advertisements

A sideshow object may contain advertisement information. In one embodiment, an advertisement sideshow object may be displayed on a second display screen in the same way as any other sideshow object. Advertisement sideshow objects in the present embodiment are referred to as “static.” Optionally, an advertisement sideshow object may be displayed with a banner alerting the viewer that an advertisement is being displayed. The banner may have the verbiage of, for example, “this is an ad” or “sponsored.”

In one embodiment, the display of an advertisement sideshow object may be controlled using a demographic profile. Advertisement sideshow objects in the present embodiment are referred to as “dynamic.” A dynamic advertisement sideshow object is associated with a demographic profile. The demographic profile may include attributes such as viewer age, viewer gender, viewer location (e.g., GPS coordinates, CPE billing address, and so forth), viewer television watching history, viewer sideshow watching history, advertiser Herfindahl index (HHI), and so forth. The likelihood of a dynamic advertisement sideshow object being displayed to a viewer is determined based on the closeness in match between the demographic profile of the sideshow object and the demographic of the viewer.

### 4. Archiving and Delivering Social TV Content

It should be appreciated that a number of authors can utilize the above described technologies for authoring Social TV content at any time. That is to say, television network writers, commentators, and/or television enthusiasts may author Social TV content before, during, and/or after the original broadcast of a television show. Further, once a sideshow object is authored and transmitted to a Social TV services provider, the Social TV services provider may make the sideshow object available for transmission to second screen displays for display, regardless of whether the television show corresponding to the Social TV content is being viewed live, in a time-shifted manner, via VOD, or is not being viewed at all. Thus, a television network writer who has viewed a pre-production version of a television show may author corresponding sideshow objects to a Social TV services provider before the initial airing of the television broadcast. Further, a commentator who is viewing a live broadcast of the television show can author sideshow objects concurrent with developments in the live television broadcast. Further still, an enthusiast who is viewing a time-shifted recording of the television show can also author corresponding sideshow objects for consumption by future viewers of time-shifted copies (or replies) of the same television show.

Note, however, that although Social TV content may be made available for viewing immediately upon the completion of the authoring process, a Social TV services provider may nonetheless restrict the delivery of Social TV content to second display screens, for reasons such as security, billing, or spoilers, for example.

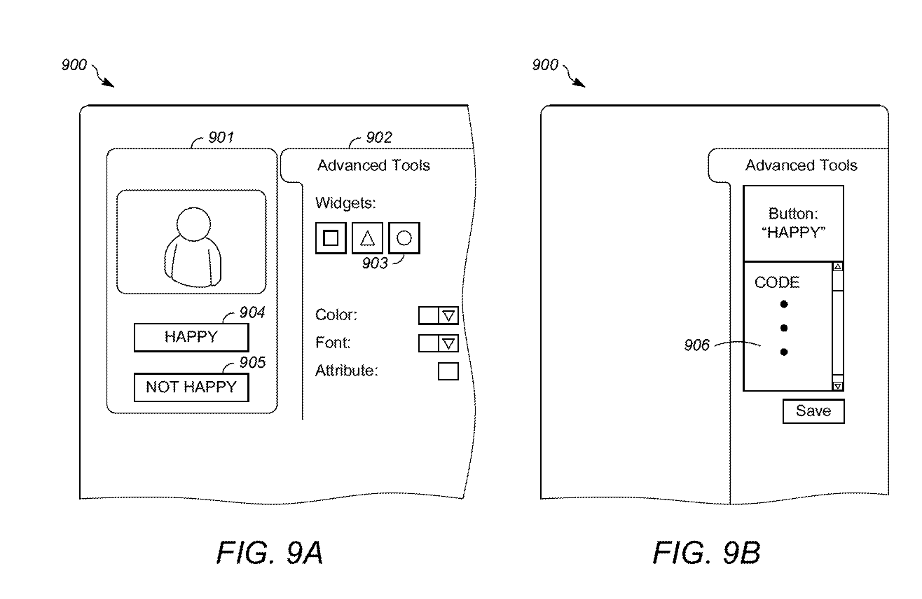

FIG. 10 illustrates exemplary authoring, archiving, and delivering of Social TV content via a Social TV system. As shown, first display screen 1011 is in communication with CPE 1013 and is displaying a televised football game. Another first display screen 1012 is in communication with CPE 1014 and is displaying an episode of a television series titled “the office.” CPEs 1013 and 1014 are in communication with network 1099. Sideshows 1015 and 1016 correspond to the football game and sideshow 1017 corresponds to the episode of “the office.”

Various Social TV content sources that author Social TV sideshow objects 1020-1021 and 1031-1038 related to sideshows 1015-1017 are also shown in FIG. 10. Content source 1018 is a nonhuman data provider of sports statistics, and provides sports statistics to Social TV services provider 1040 to be used as sideshow object 1020 in sideshows 1015 and 1016. Sideshow object 1021 is authored by a football enthusiast for use in sideshow 1015. Sideshow object 1022 is authored by another football enthusiast use in sideshow 1016. Sideshow objects 1031 and 1032 are authored by a network writer for use in sideshow 1015. Sideshow objects 1033-1035 are authored by another network writer for use in sideshow 1016. Sideshow objects 1036 and 1037 are authored by yet another network writer for use in sideshow 1017. Sideshow object 1038 is authored by an enthusiast of “the office” for use in sideshow 1017. Sideshow objects 1020-1022 and 1031-1038 may be authored using, for example, web page 400 (FIG. 4). Social TV services provider 1040 may group received sideshow objects 1020-1022 and 1031-1038 so that the sideshow objects are properly associated with sideshows 1015-1017 and television shows 1011-1012. Social TV services provider 1040 may also store the received sideshow objects in database 1042.

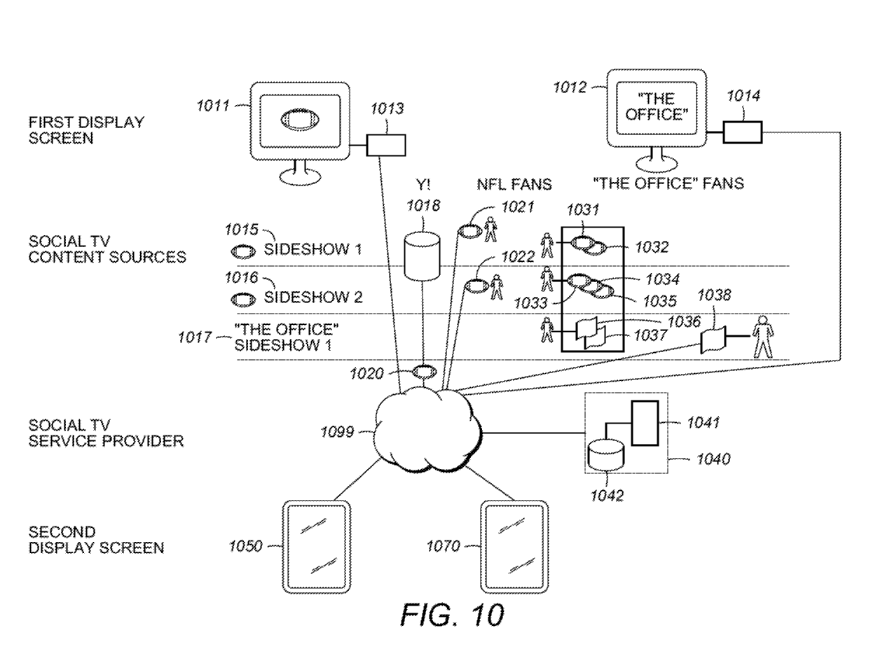

FIG. 11 illustrates an exemplary grouping of sideshow objects 1020-1022 and 1031-1038 between sideshows 1015-1017. In some embodiments, database 1142 is database 1042 of Social TV services provider 1040 (FIG. 10). As shown, sideshow objects 1031, 1020, 1021, and 1032 are associated with sideshow 1015, which is associated with the televised football game shown on first screen display 1011 (FIG. 10). Sideshow objects 1020, 1022, 1033, and 1035 are associated with sideshow 1016, which is also associated with the televised football game. Sideshow objects 1036-1038 are associated with sideshow 1017, which is associated with the episode of “the office” shown on first display screen 1012 (FIG. 10).

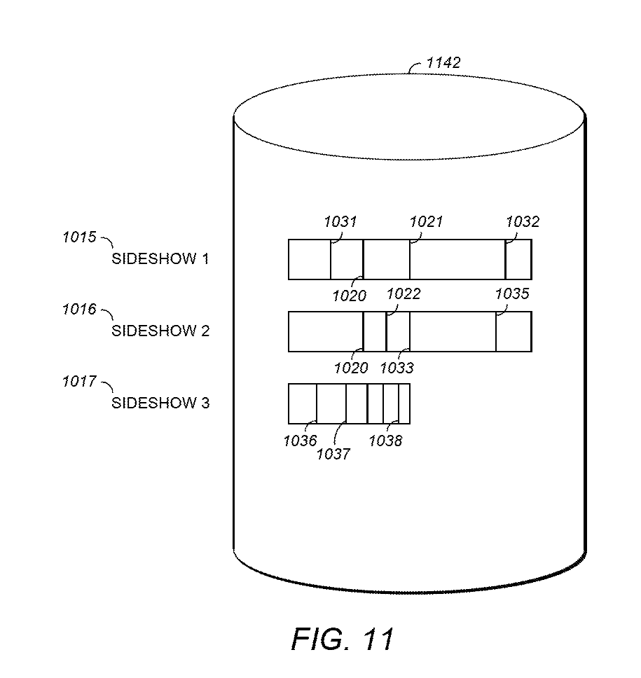

Turning back to FIG. 10, Social TV services provider 1040 may deliver sideshows 1015-1017 and their respective sideshow objects to second display screens 1050 and 1070 for display. FIG. 12 illustrates exemplary displays of two sideshows that are associated with two different television shows on second display screens 1250 and 1270. In some embodiments, second screen displays 1250 and 1270 are second screen displays 1050 and 1070 (FIG. 10), respectively. As shown, second display screen 1250 is displaying sideshow 1015 which corresponds to the football game that is displayed on first display screen 1011 (FIG. 10). Progress indicator 1252 indicates that sideshow object 1031 of sideshow 1015 is currently displayed. In addition, sideshow objects 1020, 1021, and 1032 are also available for display. In similar fashion, second screen display 1270 is displaying sideshow 1017 which corresponds to the episode of “the office” that is displayed on first display screen 1012 (FIG. 10). Progress indicator 1272 indicates that sideshow object 1036 of sideshow 1017 is currently displayed. In addition, sideshow objects 1037 and 1038, among other (unlabeled) sideshow objects, are also available for display.

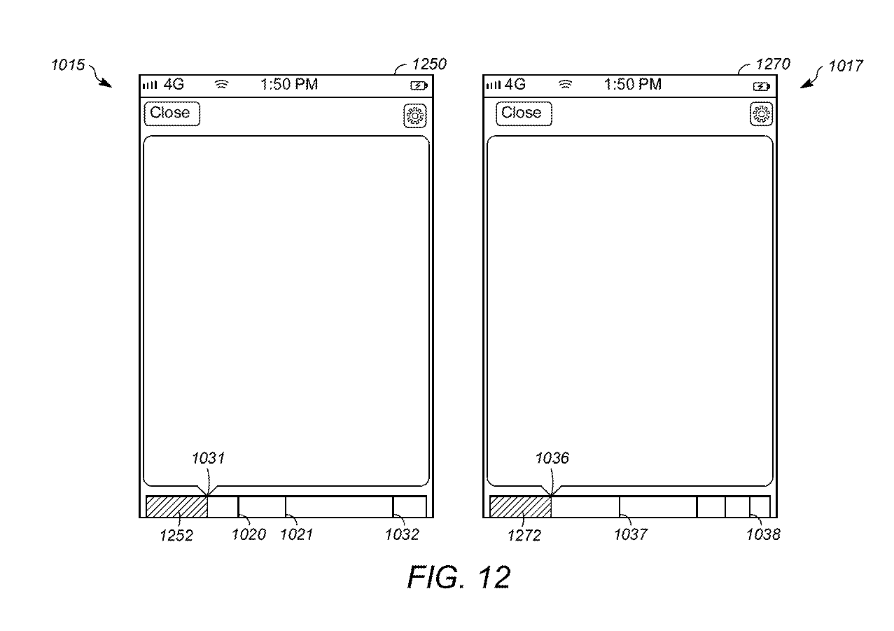

FIG. 13 illustrates exemplary displays of two different sideshows associated with the same television show on second display screens 1350 and 1370. In some embodiments, second screen displays 1350 and 1370 are second screen displays 1050 and 1070 (FIG. 10), respectively. As shown, second display screen 1350 is displaying sideshow 1015 which corresponds to the football game that is displayed on first display screen 1011 (FIG. 10). Progress indicator 1352 indicates that sideshow object 1021 of sideshow 1015 is currently displayed. In addition, sideshow object 1032 is also available for display. Although not shown, a viewer may cause sideshow objects 1021 and 1020 (FIG. 11) to be displayed by dragging progress indicator 1352 in the left direction. Second screen display 1370 is displaying sideshow 1016 which also corresponds to the same football game. Progress indicator 1372 indicates that sideshow object 1033 of sideshow 1016 is currently displayed. In addition, sideshow objects 1034 and 1035 are available for display. Although not shown, a viewer may cause sideshow objects 1020 and 1022 (FIG. 11) to be displayed by dragging progress indicator 1372 in the left direction.

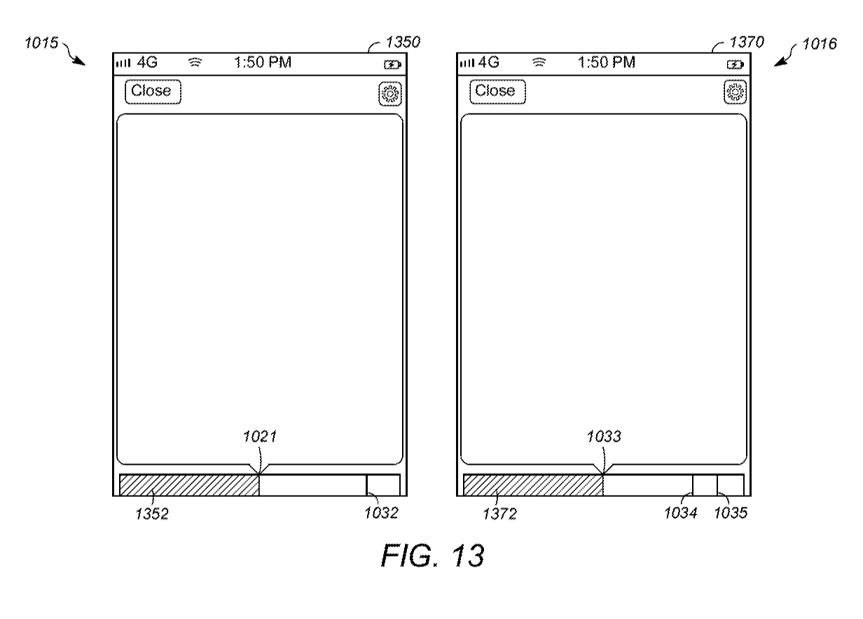

FIG. 14 illustrates exemplary displays of two time-shifted portions of sideshow 1015 on second display screens 1450 and 1470. In some embodiments, second screen displays 1450 and 1470 are second screen displays 1050 and 1070 (FIG. 10), respectively. As shown, second display screen 1450 is displaying sideshow 1015 which corresponds to the football game displayed on first display screen 1011 (FIG. 10). Progress indicator 1352 indicates that sideshow object 1031 of sideshow 1015 is currently displayed. In addition, sideshow objects 1020, 1021, and 1032 are available for display. Similarly, second screen display 1470 is also displaying sideshow 1015. Progress indicator 1372 indicates that sideshow object 1032 of sideshow 1015 is currently displayed. Although not shown, a viewer may cause sideshow objects 1031, 1020, and 1021 to be displayed by dragging progress indicator 1472 in the left direction.

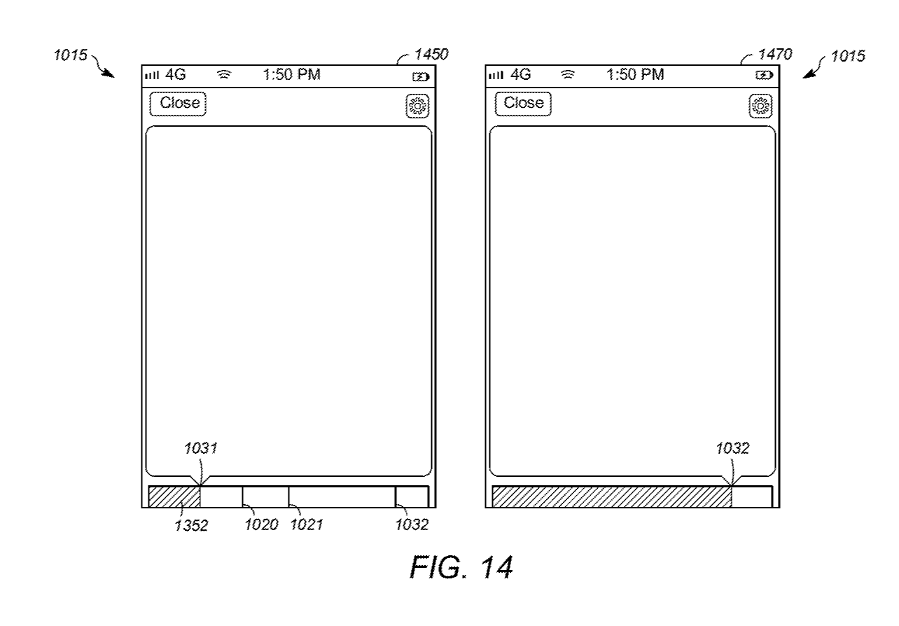

FIG. 15 illustrates exemplary method 1500 for carrying out various techniques of Social TV system 200 (FIG. 2) discussed above. At block 1510, a server within a Social TV system, such as server 211 (FIG. 2), receives the identity of a television show that is being displayed on a first display screen. The server may include an internet information services engine and/or middleware that allows for the retrieval and/or receiving, by the server, of information. The identity of the television show may be later used by Social TV system to control the delivery of Social TV content to a second display screen. At block 1520, the server receives a sideshow content object from a Social TV content author. At block 1530, the server receives a sideshow content object from another Social TV content author. Note, it may be possible for the server to receive additional sideshow content objects, whether from the same Social TV content authors or other Social TV content authors. Sideshow content objects received by the server are stored in a repository, such as database 212 (FIG. 2). At block 1540, the server transmits one or more sideshow content objects to a second display screen. The transmitted sideshow content objects may then be displayed on the second display screen based on the playback position of the television show on the first display screen.

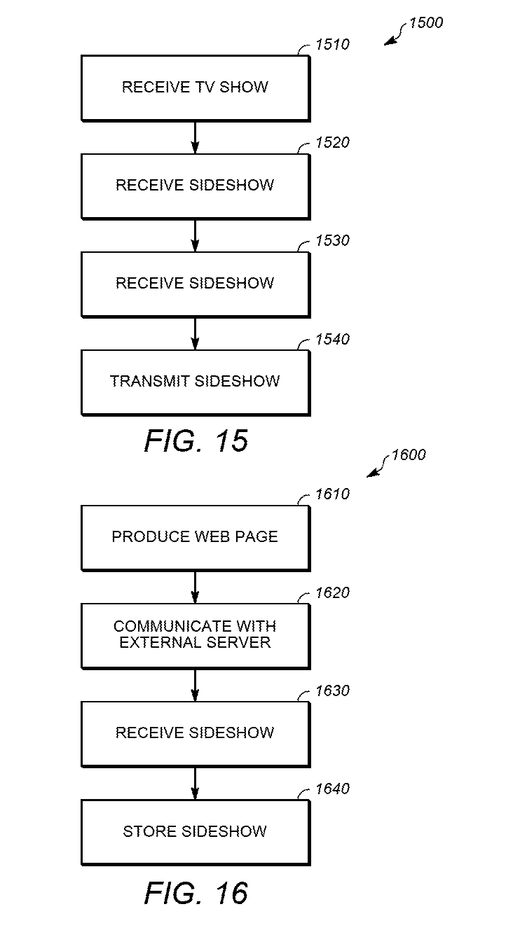

FIG. 16 illustrates exemplary method 1600 for carrying out various techniques of Social TV system 200 (FIG. 2) discussed above. At block 1610, a server within a Social TV system, such as server 211 (FIG. 2), produces a web page that is to be used by a Social TV content author to author a sideshow content object. The server may include an internet information services engine and/or middleware that produces web pages. Optionally, in generating the web page, the server may perform block 1620, in which the server communicates with an external server for content that may be used in the authoring of a sideshow content object. The types of objects that may be obtained and the types of external servers that may be accessed are discussed above. The obtained objects are displayed in the web page to be used by a Social TV content author, and may be used by the Social TV content author in the authoring of a sideshow content object. At block 1630, the server receives, from the Social TV content author, contents representing an authored sideshow content object. The server may include an internet information services engine and/or middleware that receives information. At block 1640, the server stores the received sideshow content object in a repository, such as database 212 (FIG. 2).

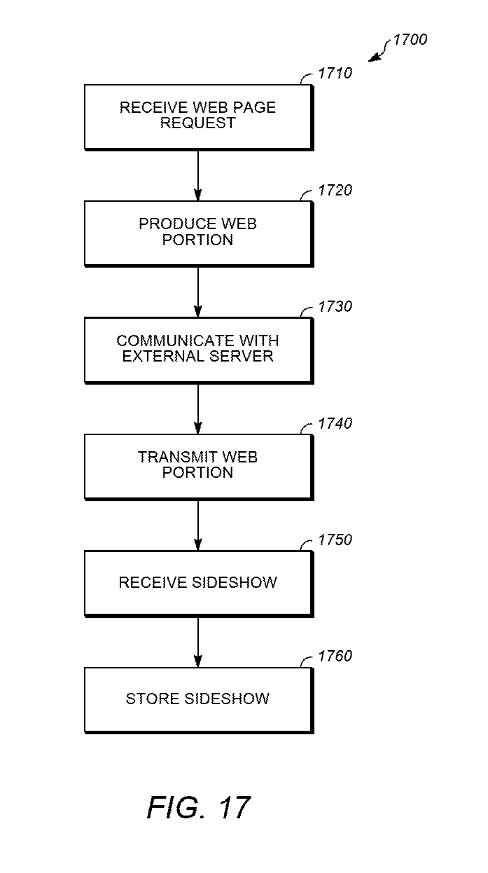

FIG. 17 illustrates exemplary method 1700 for carrying out various techniques of Social TV system 200 (FIG. 2) discussed above. At block 1710, a server within a Social TV system, such as server 211 (FIG. 2), receives a request from an external server for a web page portion. At block 1720, the server produces a web page portion that is to be used by a Social TV content author to author a sideshow content object. The server may include an internet information services engine and/or middleware that produces web page portions. Optionally, in generating the web page, the server may perform block 1730, in which the server communicates with a first external server for content that may be used in the authoring of a sideshow content object. The obtained objects are included in the web page portion produced by the server. At block 1740, the server transmits the web page portion to a second external server so that the second external server may present the transmitted web page portion as a portion of a larger web page. The larger web page may be used by a Social TV content author to author a sideshow content object. The web page portion transmitted by the server may be incorporated as part of an HTML “iframe” element into the larger web page by the second external server. At block 1750, the server receives, from the Social TV content author, contents representing an authored sideshow content object. At block 1760, the server stores the received sideshow content object in a repository, such as database 212 (FIG. 2). The server may include an internet information services engine and/or middleware that receives information.

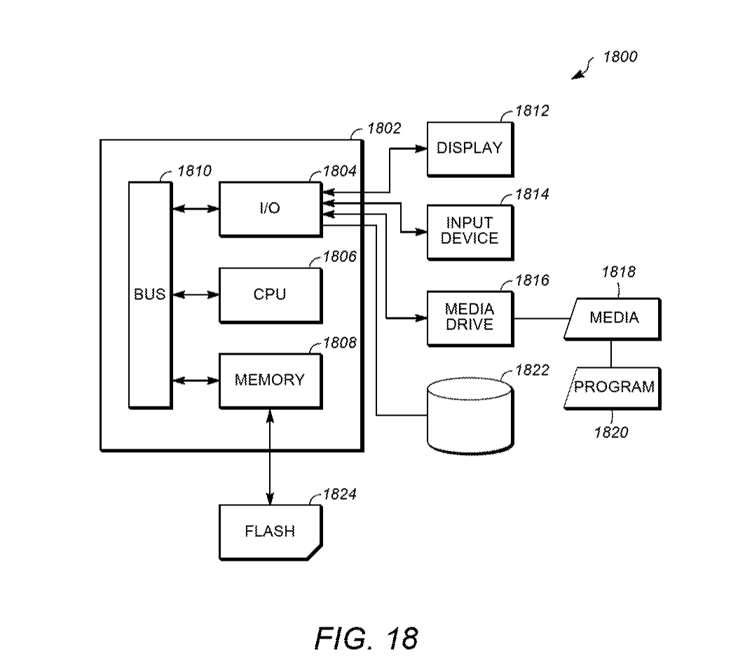

Portions of Social TV system 200 (FIG. 2) described above may be implemented in exemplary computing system 1800. In some embodiments, computer system 1800 is connected to a cloud network, which may provide additional processing and/or storage resources to computer system 1800. In some embodiments, computer system 1800 is itself a component of a cloud network, and provides processing and/or storage resources to other components of the cloud network. The use of a cloud network allows the portions of Social TV system 200 that are provided by computing system 1800 to be accessible to the various entities in the Social TV system. These entities may include, but are not limited to, human and nonhuman content sources, MSOs, CPEs, television viewers (and/or Social TV viewers), first display screens, second display screens, third-party websites, or the like. As shown in FIG. 18, the computer system 1800 includes a computer motherboard 1802 with bus 1810 that connects I/O section 1804, one or more central processing units (CPU) 1806, and a memory section 1808 together. Memory section 1808 may have flash memory device 1824 related to it. The I/O section 1804 may be connected to display 1812, input device 1814, media drive unit 1816 and/or disk storage unit 1822. The media drive unit 1816 can read and/or write a computer-readable medium 1818, which can contain computer executable instructions 1820 and/or data.

At least some values based on the results of the above-described processes can be saved into memory such as memory 1808, flash memory device 1824, computer-readable medium 1818, and/or disk storage unit 1822 for subsequent use. Additionally, computer-readable medium 1818 can be used to store (e.g., tangibly embody) one or more computer programs for performing any one of the above-described processes by means of a computer. The computer program may be written, for example, in a general-purpose programming language (e.g., Pascal, C, C++, Java) or some specialized application-specific language.

Although only certain exemplary embodiments have been described in detail above, those skilled in the art will readily appreciate that many modifications are possible in the exemplary embodiments without materially departing from the novel teachings and advantages of this disclosure. For example, aspects of embodiments disclosed above can be combined in other combinations to form additional embodiments. Accordingly, all such modifications are intended to be included within the scope of this technology.

What is claimed is:

1. A non-transitory computer-readable storage medium having computer-executable instructions for delivering internet-based social television content to a television viewer, the computer-executable instructions comprising instructions for:
receiving, at a server, the identity of a television show, wherein the television show is currently displayed on a first display screen;
receiving, at the server, a first social television content object from a first social television content source, wherein:
the first social television content object corresponds to a portion of a first television show of a plurality of television shows, and the first social television content object comprises visual data;
receiving, at the server, a second television content object from a second social television content source, wherein:
the second social television content object corresponds to a portion of a second television show of the plurality of television shows, the second social television content object comprises visual data, and the second source is different from the first source; and
transmitting, by the server for display on a second display screen, one of the first social television content object and the second social television content object, based on the received identity of the currently displayed television show, wherein:
the transmitted social television content object corresponds to a portion of the currently displayed television show, and the transmitted social television content object is to be displayed on the second display screen when the corresponding portion of the currently displayed television show is displayed on the first display screen.

2. The non-transitory computer-readable storage medium of claim 1, wherein the first social television content source is a user of a website other than the television viewer.

3. The non-transitory computer-readable storage medium of claim 1, wherein the first social television content object comprises additional computer-executable instructions for execution on a computer device connected to the second display screen.

4. The non-transitory computer-readable storage medium of claim 3, wherein the additional computer-executable instructions comprises instructions to initiate a cellular telephone or a notification function on the computer device connected to the second display screen.

5. The non-transitory computer-readable storage medium of claim 4, wherein the cellular telephone instruction is a SMS function.

6. The non-transitory computer-readable storage medium of claim 4, wherein the notification function is a push notification.

7. The non-transitory computer-readable storage medium of claim 3, wherein the additional computer-executable instructions comprises at least one branch of logic that is to be executed based on input from the viewer.

8. The non-transitory computer-readable storage medium of claim 3, wherein the additional computer-executable instructions enable the viewer to share information with another viewer.

9. The non-transitory computer-readable storage medium of claim 1, wherein the first social television content object comprises additional computer-executable instructions for initiating server-side computer-executable instructions on a server and for receiving output from the server-side computer-executable instructions from the server.

10. The non-transitory computer-readable storage medium of claim 1, wherein the visual data comprises advertising information.

11. The non-transitory computer-readable storage medium of claim 10, wherein the advertising information is displayed on the second display screen based on closeness between a demographic profile of the advertising information and the demographic of the viewer.

12. The non-transitory computer-readable storage medium of claim 10, wherein the visual data contains a link to an e-commerce merchant, and a commission is associated with the first content source if a viewer accesses the e-commerce merchant using the link and makes a purchase from the e-commerce merchant.

13. The non-transitory computer-readable storage medium of claim 1, wherein the first social television content source identifies the first social television content object to the server using an internet uniform resource locator.

14. The non-transitory computer-readable storage medium of claim 13, wherein the uniform resource locator refers to a social media or e-commerce website.

15. The non-transitory computer-readable storage medium of claim 1, wherein the transmitted social television content object is displayed on the second display screen based on a time index of the currently displayed television show.

16. The non-transitory computer-readable storage medium of claim 1, wherein the transmitted social television content object is received at the server after the identity of the currently displayed television show is obtained.

17. The non-transitory computer-readable storage medium of claim 1, wherein the transmitted social television content object is received at the server before the identity of the currently displayed television show is obtained.

18. The non-transitory computer-readable storage medium of claim 1, wherein the transmitting of the social television content object is further based on the viewer's selection.

19. The non-transitory computer-readable storage medium of claim 1, wherein the transmitting of the social television content object is further based on the demographic of the viewer.

20. The non-transitory computer-readable storage medium of claim 1, wherein the transmitting of the social television content object is further based on a social television content object that was previously displayed on the second display screen.

21. A non-transitory computer-readable storage medium having computer-executable instructions for authoring internet-based social television content to be displayed contemporaneously with a display of a television show on a first screen, the computer-executable instructions comprising instructions for:
retrieving, from a website accessible using a uniform resource locator, a plurality of objects from the website, wherein the objects refer to user-generated content;
displaying a web page to a social television content author, wherein:
the web page comprises a region for authoring a social television content object,
the web page references at least one of the plurality of retrieved objects, and
the web page allows the television content author to select at least one of the plurality of retrieved objects for association with the social television content object; and
receiving the authored social television content object, wherein the authored social television content object is to be displayed on a second display screen when the corresponding portion of the television show is displayed on the first display screen.

22. The non-transitory computer-readable storage medium of claim 21, wherein the web page comprises a region for receiving additional computer-executable instructions to be executed on a computer device connected to the second display screen.

23. The non-transitory computer-readable storage medium of claim 22, wherein the additional computer-executable instructions is HTML5 source code.

24. The non-transitory computer-readable storage medium of claim 22, wherein the additional computer-executable instructions initiate a cellular telephone or notification function on the computer device connected to the second display screen.

25. The non-transitory computer-readable storage medium of claim 22 wherein the additional computer-executable instructions comprises at least one branch of logic that is to be executed based on input from the viewer.

26. The non-transitory computer-readable storage medium of claim 22, wherein the additional computer-executable instructions enable the viewer to share information with another viewer.

27. The non-transitory computer-readable storage medium of claim 21, wherein the web page comprises a region for receiving additional computer-executable instructions for causing a computer device connected to the second display screen to initiate server-side computer-executable instructions on a server and to receive output from the server-side computer-executable instructions from the server.

28. The non-transitory computer-readable storage medium of claim 21, wherein the website is a social media or e-commerce website.

29. The non-transitory computer-readable storage medium of claim 21, wherein the uniform resource locator is provided by the social television content author.

30. The non-transitory computer-readable storage medium of claim 21, wherein:
the web page comprises a region for receiving advertising information to be displayed on the second display screen,
the advertising information is displayed on the second display screen based on closeness between a demographic profile of the advertising information and the demographic of a viewer.

31. The non-transitory computer-readable storage medium of claim 21, wherein the social television content object comprises a link to an e-commerce merchant, and a commission is associated with the first content source if a viewer accesses the e-commerce merchant using the link and makes a purchase from the e-commerce merchant.

32. A non-transitory computer-readable storage medium having computer-executable instructions for authoring internet-based social television content to be displayed contemporaneously with a display of a television show on a first screen, the computer-executable instructions comprising instructions for:
retrieving, from a first web server accessible by a uniform resource locator, a plurality of objects from the first web server, wherein the objects refer to user-generated content;
generating a web page portion, wherein:
the web page portion comprises a region for authoring a social television content object,
the web page portion references at least one of the plurality of retrieved objects,
the web page allows the television content author to select at least one of the plurality of retrieved objects for inclusion into the social television content object, and
the social television content object is to be displayed on a second display screen when the corresponding portion of the television show is displayed on the first display screen;
transmitting, to a second web server, the generated web page portion, wherein the generated web page portion is added to a web page, the web page for display to a social television content author; and
receiving, from the social television content author, data representing an authored social television content object.

33. The non-transitory computer-readable storage medium of claim 32, wherein the generated web page portion is transmitted to the second web server using HTML, JavaScript, and CSS.

34. The non-transitory computer-readable storage medium of claim 32, wherein the web page portion is generated by a social television services provider and the second web server is a social media website.

35. The non-transitory computer-readable storage medium of claim 32, wherein the generated web page portion is added to the web page using an HTML iframe element.

36. The non-transitory computer-readable storage medium of claim 32, wherein the web page comprises a region for receiving additional computer-executable instructions to be executed on a computer device connected to the second display screen.

37. The non-transitory computer-readable storage medium of claim 36, wherein the additional computer-executable instructions is HTML5 source code.

38. The non-transitory computer-readable storage medium of claim 36, wherein the additional computer-executable instructions initiate a telephone or SMS function on the computer device connected to the second display screen.

39. The non-transitory computer-readable storage medium of claim 36, wherein the additional computer-executable instructions comprises at least one branch of logic that is to be executed based on input from the viewer.

40. The non-transitory computer-readable storage medium of claim 36, wherein the additional computer-executable instructions enable the viewer to share information with another viewer.

41. The non-transitory computer-readable storage medium of claim 32, wherein the web page comprises a region for receiving additional computer-executable instructions for causing a computer device connected to the second display screen to initiate server-side computer-executable instructions on a server and to receive output from the server-side computer-executable instructions from the server.

42. The non-transitory computer-readable storage medium of claim 32, wherein the first web server is a social media or e-commerce website.

43. The non-transitory computer-readable storage medium of claim 32, wherein the uniform resource locator is provided by the social television content author.

44. The non-transitory computer-readable storage medium of claim 32, wherein:
the web page comprises a region for receiving advertising information to be displayed on the second display screen,
the advertising information is displayed on the second display screen based on closeness between a demographic profile of the advertising information and the demographic of a viewer.

45. The non-transitory computer-readable storage medium of claim 32, wherein the social television content object comprises a link to an e-commerce merchant, and a commission is associated with the first content source if a viewer accesses the e-commerce merchant using the link and makes a purchase from the e-commerce merchant.

46. An internet server device connected to the internet for delivering social television content via the internet to a television viewer, the server device comprising:
a receiver adapted to:
receive the identity of a television show, wherein the television show is currently displayed on a first display screen;
receive a first social television content object from a first social television content source, wherein the first social television content object corresponds to a portion of a first television show of a plurality of television shows, and the first social television content object comprises visual data;
receive a second television content object from a second social television content source, wherein the second social television content object corresponds to a portion of a second television show of the plurality of television shows, the second social television content object comprises visual data, and the second source is different from the first source; and
an internet information server adapted to:
transmit, for display on a second display screen, one of the first social television content object and the second social television content object, based on the received identity of the currently displayed television show, wherein:
the transmitted social television content object corresponds to a portion of the currently displayed television show, and the transmitted social television content object is to be displayed on the second display screen when the corresponding portion of the currently displayed television show is displayed on the first display screen.

47. The device of claim 46, wherein the first social television content source is a user of a website other than the television viewer.

48. The device of claim 46, wherein the first social television content object comprises computer-executable instructions for execution on a computer device connected to the second display screen.

49. The device of claim 48, wherein the computer-executable instructions comprises instructions to initiate a cellular telephone or a notification function on the computer device connected to the second display screen.

50. The device of claim 49, wherein the cellular telephone instruction is a SMS function.

51. The device of claim 49, wherein the notification function is a push notification.

52. The device of claim 48, wherein the computer-executable instructions comprises at least one branch of logic that is to be executed based on input from the viewer.

53. The device of claim 48, wherein the computer-executable instructions enable the viewer to share information with another viewer.

54. The device of claim 46, wherein the first social television content object comprises computer-executable instructions for initiating server-side computer-executable instructions on a server and for receiving output from the server-side computer-executable instructions from the server.

55. The device of claim 46, wherein the visual data comprises advertising information.

56. The device of claim 55, wherein the advertising information is displayed on the second display screen based on closeness between a demographic profile of the advertising information and the demographic of the viewer.

57. The device of claim 55, wherein the visual data contains a link to an e-commerce merchant, and a commission is associated with the first content source if a viewer accesses the e-commerce merchant using the link and makes a purchase from the e-commerce merchant.

58. The device of claim 46, wherein the first social television content source identifies the first social television content object to the server using an internet uniform resource locator.

59. The device of claim 58, wherein the uniform resource locator refers to a social media or e-commerce website.

60. The device of claim 46, wherein the transmitted social television content object is displayed on the second display screen based on a time index of the currently displayed television show.

61. The device of claim 46, wherein the transmitted social television content object is received at the server after the identity of the currently displayed television show is obtained.

62. The device of claim 46, wherein the transmitted social television content object is received at the server before the identity of the currently displayed television show is obtained.

63. The device of claim 46, wherein the transmitting of the social television content object is further based on the viewer's selection.

64. The device of claim 46, wherein the transmitting of the social television content object is further based on the demographic of the viewer.

65. The device of claim 46, wherein the transmitting of the social television content object is further based on a social television content object that was previously displayed on the second display screen.

66. An internet server device connected to the internet for authoring social television content to be displayed contemporaneously with a display of a television show on a first screen, the server device comprising:
an internet information retriever adapted to:
retrieve, from a website accessible using a uniform resource locator, a plurality of objects from the website, wherein the objects refer to user-generated content;
a web page server adapted to:
create a web page, wherein:
the web page comprises comprising a region for authoring a social television content object,
the web page references at least one of the plurality of retrieved objects, and
the web page allows the television content author to select at least one of the plurality of retrieved objects for association with the social television content object;
transmit the created web page to a social television content author for display; and
receive the authored social television content object, wherein the authored social television content object is to be displayed on a second display screen when the corresponding portion of the television show is displayed on the first display screen.

67. The device of claim 66, wherein the web page comprises a region for receiving computer-executable instructions to be executed on a computer device connected to the second display screen.

68. The device of claim 66, wherein the computer-executable instructions is HTML5 source code.

69. The device of claim 67, wherein the computer-executable instructions initiate a cellular telephone or notification function on the computer device connected to the second display screen.

70. The device of claim 67 wherein the computer-executable instructions comprises at least one branch of logic that is to be executed based on input from the viewer.

71. The device of claim 67, wherein the computer-executable instructions enable the viewer to share information with another viewer.

72. The device of claim 66, wherein the web page comprises a region for receiving computer-executable instructions for causing a computer device connected to the second display screen to initiate server-side computer-executable instructions on a server and to receive output from the server-side computer-executable instructions from the server.

73. The device of claim 66, wherein the website is a social media or e-commerce website.

74. The device of claim 66, wherein the uniform resource locator is provided by the social television content author.

75. The device of claim 66, wherein:
the web page comprises a region for receiving advertising information to be displayed on the second display screen,
the advertising information is displayed on the second display screen based on closeness between a demographic profile of the advertising information and the demographic of a viewer.

76. The device of claim 66, wherein the social television content object comprises a link to an e-commerce merchant, and a commission is associated with the first content source if a viewer accesses the e-commerce merchant using the link and makes a purchase from the e-commerce merchant.

77. An internet server device connected to the internet for authoring social television content to be displayed contemporaneously with a display of a television show on a first screen, the server device comprising:
an internet information retriever adapted to:
retrieve, from a first web server accessible by a uniform resource locator, a plurality of objects from the first web server, wherein the objects refer to user-generated content;
an internet information server adapted to:
generate a web page portion, wherein:
the web page portion comprises a region for authoring a social television content object,
the web page portion references at least one of the plurality of retrieved objects,
the web page allows the television content author to select at least one of the plurality of retrieved objects for inclusion into the social television content object, and
the social television content object is to be displayed on a second display screen when the corresponding portion of the television show is displayed on the first display screen;
transmit, to a second web server, the generated web page portion, wherein the generated web page portion is added to a web page, the web page for display to a social television content author; and
receive, from the social television content author, data representing an authored social television content object.

78. The device of claim 77, wherein the generated web page portion is transmitted to the second web server using HTML, JavaScript, and CSS.

79. The device of claim 77, wherein the web page portion is generated by a social television services provider and the second web server is a social media website.

80. The device of claim 77, wherein the generated web page portion is added to the web page using an HTML iframe element.

81. The device of claim 77, wherein the web page comprises a region for receiving computer-executable instructions to be executed on a computer device connected to the second display screen.

82. The device of claim 81, wherein the computer-executable instructions is HTML5 source code.

83. The device of claim 81, wherein the computer-executable instructions initiate a telephone or SMS function on the computer device connected to the second display screen.

84. The device of claim 81, wherein the computer-executable instructions comprises at least one branch of logic that is to be executed based on input from the viewer.

85. The device of claim 81, wherein the computer-executable instructions enable the viewer to share information with another viewer.

86. The device of claim 77, wherein the web page comprises a region for receiving computer-executable instructions for causing a computer device connected to the second display screen to initiate server-side computer-executable instructions on a server and to receive output from the server-side computer-executable instructions from the server.

87. The device of claim 77, wherein the first web server is a social media or e-commerce website.

88. The device of claim 77, wherein the uniform resource locator is provided by the social television content author.

89. The device of claim 77, wherein:
the web page comprises a region for receiving advertising information to be displayed on the second display screen,
the advertising information is displayed on the second display screen based on closeness between a demographic profile of the advertising information and the demographic of a viewer.

90. The device of claim 77, wherein the social television content object comprises a link to an e-commerce merchant, and a commission is associated with the first content source if a viewer accesses the e-commerce merchant using the link and makes a purchase from the e-commerce merchant.

91. A computer-implemented method for delivering internet-based social television content to a television viewer, the method comprising:
receiving, at a server, the identity of a television show, wherein the television show is currently displayed on a first display screen;
receiving, at the server, a first social television content object from a first social television content source, wherein:
the first social television content object corresponds to a portion of a first television show of a plurality of television shows, and the first social television content object comprises visual data;
receiving, at the server, a second television content object from a second social television content source, wherein:
the second social television content object corresponds to a portion of a second television show of the plurality of television shows, the second social television content object comprises visual data, and the second source is different from the first source; and
transmitting, by the server for display on a second display screen, one of the first social television content object and the second social television content object, based on the received identity of the currently displayed television show, wherein:
the transmitted social television content object corresponds to a portion of the currently displayed television show, and the transmitted social television content object is to be displayed on the second display screen when the corresponding portion of the currently displayed television show is displayed on the first display screen.

92. The method of claim 91, wherein the first social television content source is a user of a website other than the television viewer.

93. The method of claim 91, wherein the first social television content object comprises computer-executable instructions for execution on a computer device connected to the second display screen.

94. The method of claim 93, wherein the computer-executable instructions comprises instructions to initiate a cellular telephone or a notification function on the computer device connected to the second display screen.

95. The method of claim 94, wherein the cellular telephone instruction is a SMS function.

96. The method of claim 94, wherein the notification function is a push notification.

97. The method of claim 93, wherein the computer-executable instructions comprises at least one branch of logic that is to be executed based on input from the viewer.

98. The method of claim 93, wherein the computer-executable instructions enable the viewer to share information with another viewer.

99. The method of claim 91, wherein the first social television content object comprises computer-executable instructions for initiating server-side computer-executable instructions on a server and for receiving output from the server-side computer-executable instructions from the server.

100. The method of claim 91, wherein the visual data comprises advertising information.

101. The method of claim 100, wherein the advertising information is displayed on the second display screen based on closeness between a demographic profile of the advertising information and the demographic of the viewer.

102. The method of claim 100, wherein the visual data contains a link to an e-commerce merchant, and a commission is associated with the first content source if a viewer accesses the e-commerce merchant using the link and makes a purchase from the e-commerce merchant.

103. The method of claim 91, wherein the first social television content source identifies the first social television content object to the server using an internet uniform resource locator.

104. The method of claim 103, wherein the uniform resource locator refers to a social media or e-commerce website.

105. The method of claim 91, wherein the transmitted social television content object is displayed on the second display screen based on a time index of the currently displayed television show.

106. The method of claim 91, wherein the transmitted social television content object is received at the server after the identity of the currently displayed television show is obtained.

107. The method of claim 91, wherein the transmitted social television content object is received at the server before the identity of the currently displayed television show is obtained.

108. The method of claim 91, wherein the transmitting of the social television content object is further based on the viewer's selection.

109. The method of claim 91, wherein the transmitting of the social television content object is further based on the demographic of the viewer.

110. The method of claim 91, wherein the transmitting of the social television content object is further based on a social television content object that was previously displayed on the second display screen.

111. A computer-implemented method for authoring internet-based social television content to be displayed contemporaneously with a display of a television show on a first screen, the method comprising:
retrieving, from a website accessible using a uniform resource locator, a plurality of objects from the website, wherein the objects refer to user-generated content;
displaying a web page to a social television content author, wherein:
the web page comprises a region for authoring a social television content object,
the web page references at least one of the plurality of retrieved objects, and
the web page allows the television content author to select at least one of the plurality of retrieved objects for association with the social television content object; and
receiving the authored social television content object, wherein the authored social television content object is to be displayed on a second display screen when the corresponding portion of the television show is displayed on the first display screen.

112. The method of claim 111, wherein the web page comprises a region for receiving computer-executable instructions to be executed on a computer device connected to the second display screen.

113. The method of claim 112, wherein the computer-executable instructions is HTML5 source code.

114. The method of claim 112, wherein the computer-executable instructions initiate a cellular telephone or notification function on the computer device connected to the second display screen.

115. The method of claim 112 wherein the computer-executable instructions comprises at least one branch of logic that is to be executed based on input from the viewer.

116. The method of claim 112, wherein the computer-executable instructions enable the viewer to share information with another viewer.

117. The method of claim 112, wherein the web page comprises a region for receiving computer-executable instructions for causing a computer device connected to the second display screen to initiate server-side computer-executable instructions on a server and to receive output from the server-side computer-executable instructions from the server.

118. The method of claim 112, wherein the website is a social media or e-commerce website.

119. The method of claim 112, wherein the uniform resource locator is provided by the social television content author.

120. The method of claim 112, wherein:
the web page comprises a region for receiving advertising information to be displayed on the second display screen,
the advertising information is displayed on the second display screen based on closeness between a demographic profile of the advertising information and the demographic of a viewer.

121. The method of claim 112, wherein the social television content object comprises a link to an e-commerce merchant, and a commission is associated with the first content source if a viewer accesses the e-commerce merchant using the link and makes a purchase from the e-commerce merchant.

122. A computer-implemented method for authoring internet-based social television content to be displayed contemporaneously with a display of a television show on a first screen, the method comprising:
retrieving, from a first web server accessible by a uniform resource locator, a plurality of objects from the first web server, wherein the objects refer to user-generated content;
generating a web page portion, wherein:
the web page portion comprises a region for authoring a social television content object,
the web page portion references at least one of the plurality of retrieved objects,
the web page allows the television content author to select at least one of the plurality of retrieved objects for inclusion into the social television content object, and
the social television content object is to be displayed on a second display screen when the corresponding portion of the television show is displayed on the first display screen;
transmitting, to a second web server, the generated web page portion, wherein the generated web page portion is added to a web page, the web page for display to a social television content author; and
receiving, from the social television content author, data representing an authored social television content object.

123. The method of claim 122, wherein the generated web page portion is transmitted to the second web server using HTML, JavaScript, and CSS.

124. The method of claim 122, wherein the web page portion is generated by a social television services provider and the second web server is a social media website.

125. The method of claim 122, wherein the generated web page portion is added to the web page using an HTML iframe element.

126. The method of claim 122, wherein the web page comprises a region for receiving computer-executable instructions to be executed on a computer device connected to the second display screen.

127. The method of claim 126, wherein the computer-executable instructions is HTML5 source code.

128. The method of claim 126, wherein the computer-executable instructions initiate a telephone or SMS function on the computer device connected to the second display screen.

129. The method of claim 126, wherein the computer-executable instructions comprises at least one branch of logic that is to be executed based on input from the viewer.

130. The method of claim 126, wherein the computer-executable instructions enable the viewer to share information with another viewer.

131. The method of claim 122, wherein the web page comprises a region for receiving computer-executable instructions for causing a computer device connected to the second display screen to initiate server-side computer-executable instructions on a server and to receive output from the server-side computer-executable instructions from the server.

132. The method of claim 122, wherein the first web server is a social media or e-commerce website.

133. The method of claim 122, wherein the uniform resource locator is provided by the social television content author.

134. The method of claim 122, wherein:
the web page comprises a region for receiving advertising information to be displayed on the second display screen,
the advertising information is displayed on the second display screen based on closeness between a demographic profile of the advertising information and the demographic of a viewer.

135. The method of claim 122, wherein the social television content object comprises a link to an e-commerce merchant, and a commission is associated with the first content source if a viewer accesses the e-commerce merchant using the link and makes a purchase from the e-commerce merchant.
